(19) United States
(12) Patent Application Publication
(10) Pub. No.: US 2010/0233061 A1
(43) Pub. Date: Sep. 16, 2010

(54) METHOD OF FABRICATING SUPERHYDROPHOBIC SILICA CHAIN POWDERS

(75) Inventors: Ho Sung Park, Dongnae-gu (KR); Sharad D. Bhagat, Osmanabad (IN); Jong-Hyun Lim, Suwon-si (KR); Young-Chul Joung, Suwon-si (KR); Seung-Yong Jee, Asan-si (KR); Jong-Chul Park, Asan-si (KR); In-Soon Jung, Suwon-Si (KR)

Correspondence Address: FLASTER/GREENBERG P.C.;Four Penn Center, 1600 John F. Kennedy Boulevard, 2nd Floor, PHILADELPHIA, PA, 19103, US

(73) Assignee: EM-Power Co., Ltd., Asan-si (KR)

(21) Appl. No.: 12/749,266

(22) Filed: Mar. 29, 2010

Related U.S. Application Data
(63) Continuation of application No. PCT/KR2008/000093, filed on Jan. 8, 2008.

(30) Foreign Application Priority Data
Sep. 28, 2007 (KR) 10-2007-0098157

(51) Int. Cl. C01B 33/152

(52) U.S. Cl. 423/338

(57) ABSTRACT

Disclosed herein is a method of fabricating superhydrophobic silica-based powder, comprising: forming a hydrogel by adding an organosilane compound having alkaline pH and an inorganic acid to a non-ion-exchanged water glass solution, which is a precursor, to form a mixed solution and then surface-modifying and gelating the mixed solution; dipping the hydrogel into a nonpolar solvent to solvent-exchange the hydrogel and remove sodium ions (Na+) therefrom; and drying the solvent-exchanged hydrogel through a fluidized bed drying method under normal pressure or reduced pressure to fabricate aerogel powder. According to the method of fabricating a superhydrophobic silica-based powder of the present invention, the process thereof is very simple and economical. Therefore, the present invention is expected to be industrially important.

### CROSS-REFERENCE TO RELATED APPLICATIONS

This patent application is a U.S. continuation application of International Application No. PCT/US2008/000093, filed 8 Jan. 2008, published in the English language as International Publication No. WO 2009/041752A1 on 2 Apr. 2009 the entire disclosure of which is incorporated herein by reference.

### BACKGROUND OF THE INVENTION

1. Field of the Invention

The present invention relates to a method of fabricating a superhydrophobic silica-based powder, and, more particularly, to a simple and economical method of fabricating a silica-based powder (silica aerogel powder) using a non-ion-exchanged water glass solution through a fluidized bed drying method under normal pressure or reduced pressure.

2. Description of Related Art

Silica aerogel powder is known to be the lightest existing solid. The reason is that it has a nanoporous structure having a porosity of 90% or more and a specific surface area of 600 m²/g or more. Such silica aerogel powder is utilized as an insulation material, a catalyst carrier, etc. in various scientific and industrial fields. However, the use thereof in such various application fields is extremely limited. The reason is that a supercritical fluid extraction method is used in order to dry the gel, which incurs high costs and is very risky.

In contrast, a general ambient pressure drying (APD) method is a safe and economical aerogel preparation method because the chemical surface modification of hydrogel is conducted using organosilane reagents in order to maintain the high porosity of gel, as required. However, in this ambient pressure drying method, dense particles, referred to as “zerogel”, can be formed by drying stress and capillary action during a drying process. Therefore, various researches on methods of resisting capillary action by grafting nonpolar groups have been conducted. However, the conventional ambient pressure drying method is problematic in that high costs and a lot of time are required.

groups have been conducted. However, the conventional ambient pressure drying method is problematic in that high costs and a lot of time are required.

Silica aerogel products can be manufactured using a water glass solution as a precursor. In this case, sodium ions (Na⁺) must be removed from the water glass solution through an ion exchange resin. Therefore, when silica aerogel products are manufactured in large quantities in this manner, complicated processes are required, and high costs are incurred. Furthermore, when surface modification and solvent exchange are conducted in a conventional manner, there are problems in that a lot of time and expensive chemicals are required, and thus the manufacturing cycle time and production costs are increased.

### BRIEF SUMMARY OF THE INVENTION

Accordingly, the present invention has been made keeping in mind the above problems occurring in the prior art, and an object of the present invention is to provide a simple and economical method of fabricating silica-based powder (silica aerogel powder) by employing a method of drying wet gel using a cheap precursor, such as a water glass solution, through a fluidized bed drying method under normal pressure or reduced pressure.

The present invention provides a method of fabricating silica-based powder by drying wet gel through a fluidized bed drying method. In the present invention, high expenses and risks, attributable to the use of a conventional supercritical fluid extraction method, are eliminated, costs and processing time, the increase of which have been noted as disadvantages of normal pressure drying methods which have been actively researched in recent years, are decreased, and simultaneously, dried aerogel powder can be secondarily separated due to the difference in density, and thus the process thereof is simple and economical.

That is, in order to overcome the above problems, such as surface modification and solvent exchange, which take a long time at the time of synthesizing a water glass-based aerogel using a conventional ambient pressure drying (APD) method, the present invention provides a method of fabricating aerogel powder, which can shorten the processing time of aerogel powder by as much as 5 hours by using an HNO₃/hexamethyldisilazane (HMDS) system in order to rapidly surface-modify a hydrogel through a co-precursor method and by discharging a solvent and a small amount of moisture included in a wet gel using a fluidization bed drying method for a short time. This method of fabricating aerogel powder is very important in aspects of the mass production and commercial use thereof.

The present invention provides a method of fabricating superhydrophobic silica-based powder, comprising: 1) forming a hydrogel by adding an organosilane compound having alkaline pH and an inorganic acid to a non-ion-exchanged water glass solution, which is a precursor, to form a mixed solution and then surface-modifying and gelating the mixed solution; 2) dipping the hydrogel into a nonpolar solvent to solvent-exchange the hydrogel and remove sodium ions (Na⁺) therefrom; and 3) drying the solvent-exchanged hydrogel through a fluidized bed drying method under normal pressure or reduced pressure to fabricate aerogel powder.

In the present invention, the water glass solution may be an inorganic precursor containing 29 wt % of silica, and may be used in the range of 1 to 10 wt % by diluting the precursor with deionized water. Further, the organosilane compound may be hexamethyldisilazane (HMDS), and the inorganic acid may be acetic acid or hydrochloric acid.

In the present invention, the surface modification of the mixed solution, formed by adding the organosilane compound to the water glass solution, may be conducted through a co-precursor method, and the hydrogel obtained through the co-precursor method may be dipped into a nonpolar solvent to solvent-exchange the hydrogel and remove sodium ions (Na+) therefrom. Further, the solvent-exchange of the hydrogel and the removal of sodium ions (Na+) from the hydrogel may be conducted at a temperature ranging from room temperature to 60° C. within 10 hours, and the nonpolar solvent may be hexane or heptane.

Further, in the present invention, the drying of the wet gel may be conducted at a temperature ranging from 100° C. to 200° C. using a fluidized bed drying method under normal pressure or reduced pressure. Moreover, the nonpolar solvent may be recollected by the condensation of vapor in the drying of the wet gel.

The method of fabricating superhydrophobic silica-based powder according to the present invention may further include, between step 2) and step 3): washing the hydrogel with water, or applying a vacuum or pressure to the hydrogel to remove moisture therefrom. Moreover, the method of fabricating superhydrophobic silica-based powder according to the present invention may further include, between step 2) and step 3): washing the hydrogel with water, and then applying a vacuum or pressure to the washed hydrogel to remove moisture therefrom.

Further, in the method of fabricating superhydrophobic silica-based powder according to the present invention, between step 2) and step 3), a vacuum or pressure may be applied to the hydrogel to remove moisture therefrom, glass beads may be put into the moisture-removed hydrogel, and then air having a temperature ranging from 100° C. to 200° C. may be supplied thereto so that a solvent may be easily discharged through fluidization and friction. In this case, the aerogel powder, dried through the fluidized bed drying method, may be separated and collected by density using the supplied air. Here, the superficial velocity of the air may be 3˜15 times the minimum fluidization velocity of the glass bead in the fluidized bed, the weight of the glass bead may be 2˜6 times the weight of the hydrogel from which moisture and some of the hexane are removed, and the diameter of the glass bead may be 1.0 mm or less.

According to the method of fabricating a superhydrophobic silica-based powder of the present invention, the process thereof is very simple and economical. Therefore, the present invention is very important in industrial aspects.

### BRIEF DESCRIPTION OF THE SEVERAL VIEWS OF THE DRAWING(S)

FIG. 1 is a flowchart showing a method of fabricating a superhydrophobic silica-based powder according to an embodiment of the present invention;

FIG. 2 is a graph showing the result of the FTIR analysis of silica aerogel powder according to the embodiment of the present invention; and

FIG. 3 is photographs showing the structures of silica aerogel powder through FE-SEM according to the embodiment of the present invention.

### DETAILED DESCRIPTION OF THE INVENTION

Hereinafter, a preferred embodiment of the method of fabricating superhydrophobic silica-based powder according to the present invention will be described in detail with reference to the attached drawings.

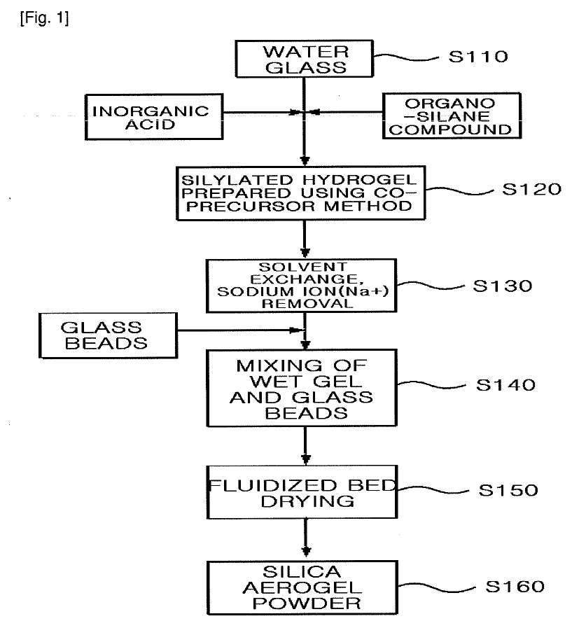

FIG. 1 is a flowchart showing a method of fabricating a superhydrophobic silica-based powder according to an embodiment of the present invention. As shown in FIG. 1, this embodiment is configured such that sodium ions (Na+) are removed through a process of removing water from silylated hydrogel through solvent exchange, without removing sodium ions (Na+) through ion exchange, which is conducted before a process of preparing the silylated hydrogel.

That is, in this embodiment, a silylated hydrogel is prepared by adding an inorganic acid (acetic acid or hydrochloric acid) and an organosilane compound to a non-ion-exchanged water glass solution and using a co-precursor method (S110 and S120). Here, the organosilane compound has an alkaline pH and conducts surface modification and gelation. Further, the water glass solution is an inorganic precursor containing 29 wt % of silica, and is used in the range of 1 to 10 wt % by diluting the precursor with deionized water. The reason for this is that, when the weight of the water glass solution is below 1 wt % or above 10 wt %, gelation is not easily realized. It is preferred that the water glass solution be used in the range of 3.5 to 5 wt %.

The reaction mechanism of the surface modification by the organosilane compound is as follows. Since pore water is discharged from the hydrogel, in order to produce silica aerogel powder of the embodiment, the hydrogel is dipped into an n-hexane solution or a heptane solution, which is a nonpolar solvent that does not mix with water. As a result, water is discharged from a reticular tissue of gel, and hexane infiltrates into the pores, thereby simultaneously completing solvent exchange and sodium ion (Na+) removal in one process (S130).

The solvent exchange and sodium ion (Na+) removal are conducted at a temperature ranging from room temperature to 60° C. within 10 hours. This solvent exchange and sodium ion (Na+) removal process, which is a process of substituting the water present in the reticular tissues of gel with hexane, can be conducted at room temperature or more. That is, the solvent exchange and sodium ion (Na+) removal require 10 hours or more at room temperature, and the substitution of the solvent is not easy at a temperature of 60° C. or more because of the volatility of hexane. Therefore, it is preferred that the solvent exchange and sodium ion (Na+) removal be conducted at a temperature of 40° C. within 3 hours, considering the characteristic of hexane, which is highly volatile.

In this embodiment, after the solvent exchange and sodium ion (Na+) removal, a process of washing the gel with water is further conducted, thereby more completely removing the sodium ions (Na+), remaining still in the gel.

Further, in this embodiment, after the solvent exchange and sodium ion (Na+) removal, moisture may be removed from the gel by applying a vacuum or pressure thereto, or by washing the gel with water and then applying a vacuum or pressure to the washed gel. That is, before the following drying process is performed, since moisture is removed from the gel by applying a vacuum or pressure thereto, there are effects in that the gel can be more easily dried, and concomitantly, hexane can also be partially removed.

The discharge of water and the drying of wet gel are conducted through a fluidized bed drying method under normal pressure or reduced pressure, without passing through an aging process. That is, the wet gel can be dried at a temperature ranging from 100° C. to 200° C., at which hexane present in the gel is volatilized. In the drying of the wet gel, when the wet gel is dried below 100° C., long periods of 2 days or more are required, and when the wet gel is dried above 200° C., it is possible to damage the structure of the gel. Preferably, the wet gel is dried in a fluidized bed drying furnace. Here, after a small amount of moisture and some of the hexane present in the wet gel are removed by applying a vacuum or pressure thereto, glass beads are mixed with the gel from which moisture and some of the hexane are removed, the mixtures are stirred such that the gel adheres on the surface of each of the glass beads, and then the stirred mixtures are put into a fluidized bed drying furnace (S140).

Subsequently, air, which is heated to a temperature of 100° C. to 200° C., is supplied to the fluidized bed drying furnace to fluidize the mixtures of the wet gel and the glass beads. As a result, a solvent is easily discharged from the wet gel, and the wet gel is dried in the form of powder by the friction between the mixtures, thereby forming the wet gel into silica aerogel powder (S150 and S160). In this case, the dried silica aerogel powder is discharged outside by the supplied air, having a temperature of 100° C. to 200° C., and is simultaneously separated and collected depending on differences in density. When a general drying furnace is used, since only a drying process can be conducted, the dried silica aerogel powder must be separated through an additional process. However, in this embodiment, since the fluidized bed drying furnace is used, the drying and separation of the silica aerogel powder can be conducted in one process. Further, in this embodiment, during the drying of wet gel, a process of re-collecting a nonpolar solvent by the condensation of vapor may be further conducted.

Further, it is preferred that the superficial velocity of the air supplied into the fluidized bed drying furnace be 3˜15 times the minimum fluidization velocity of the glass beads in the fluidized bed drying furnace. When the superficial velocity of the air is below 3 times the minimum fluidization velocity of the glass beads, fluidity is decreased, and thus it takes a long time to discharge water and dry the wet gel. Conversely, when the superficial velocity of the air is above 15 times the minimum fluidization velocity of the glass beads, inflow velocity is excessive, and thus it is possible to discharge undried gel.

Further, it is preferred that the weight of the glass bead be 2˜6 times the weight of the gel from which moisture and part of hexane are removed. When the weight of the glass beads is below 2 times of the weight of the gel, the glass beads and the gel are not uniformly mixed, and thus the drying efficiency and collection rate can be decreased. In contrast, when the weight of the glass beads is above 6 times the weight of the gel, since the gel is rigidly adhered to the glass beads and thus not discharged, collection rate and pressure are decreased, thus increasing energy consumption. Further, it is preferred that the diameter of the glass beads be 1.0 mm or less. When the diameter of the glass beads is above 1.0 mm, the minimum fluidization velocity necessary for fluidizing a packed bed is excessive, thus increasing energy consumption.

The silica aerogel powder, fabricated in such a manner, has low density and high thermal insulation properties. Further, the silica aerogel powder has superhydrophobicity, which is maintained up to a temperature of 450° C., and has hydrophilicity at temperatures above 450° C. Accordingly, the present invention is a very important technology that provides a simple and economical method, which is necessary for mass production.

### EXAMPLE

5.8 ml of hexamethyldisilazane and 4.4 ml of acetic acid were added to 50 ml of a water glass solution (4.35 wt %), which had not passed through an ion exchange process, and were then gelated to obtain hydrogel. Subsequently, the obtained hydrogel was left in an n-hexane solution (60 ml) for about 3 hours to conduct solvent exchange. After the solvent exchange, the hydrogel was extracted from a beaker, and was then dried through a fluidized bed drying method under normal pressure or reduced pressure. In this case, the drying of the hydrogel was conducted for 30 minutes by supplying air, which is heated to a temperature of 200° C., to a fluidized bed drying furnace at a superficial velocity of 26 cm/sec to obtain silica aerogel powder. The obtained silica aerogel powder exhibited low density (0.04˜0.12 g/cm³) and superhydrophobicity.

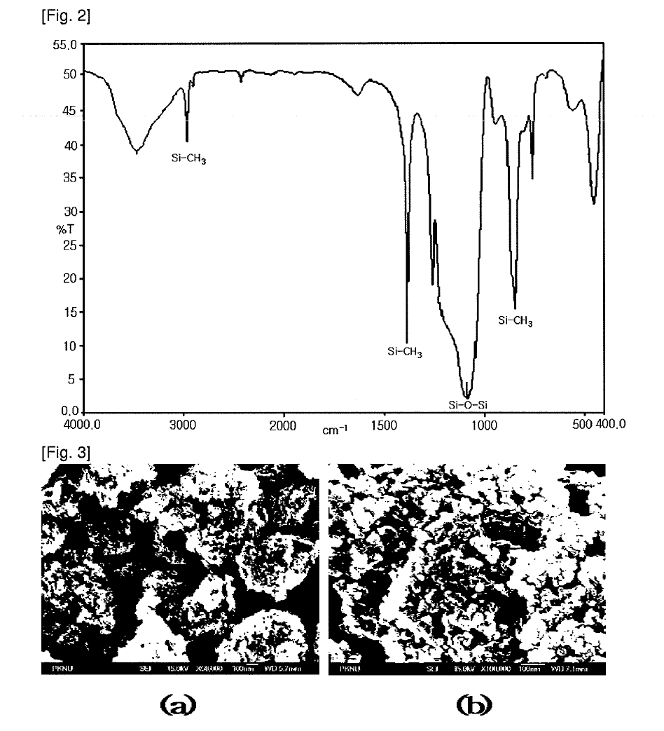

In order to evaluate the surface modification of hydrogel through a co-precursor method, the silica aerogel powder, fabricated through the above method, was analyzed using Fourier transform infrared spectroscopy (FTIR). FIG. 2 is a graph showing the result of FTIR analysis of silica aerogel powder according to the embodiment of the present invention. As shown in FIG. 2, it was found that, since the peaks of Si—CH₃ were observed, the surface modification of hydrogel through a co-precursor method was conducted.

The characteristics of the fabricated silica aerogel powder are described below.

First, the characteristics of the fabricated silica aerogel powder were evaluated through the tapping density and structure analysis thereof. Comparative data for the tapping density and structure analysis of the fabricated silica aerogel powder by stages of collecting the dried aerogel are given in Table 1.

TABLE 1

| | Tapping | Specific | |
|---|---|---|---|
| | density | surface | |
| | (g/cm³) | area(m²/g) | Reference |
| Horizontal drying | 0.102 | 748 | |
| furnace | | | |
| Fluidized bed 1 stage | 0.097 | 732 | |
| Fluidized bed 2 stage | 0.054 | 776 | |
| Fluidized bed 3 stage | 0.048 | 798 | |

The nanoporous structures of the fabricated silica aerogel powder were observed through field-emission scanning electron microscopy (FE-SEM). FIG. 3 is photographs showing the nanoporous structures of silica aerogel powder through FE-SEM according to the embodiment of the present invention, in which (a) shows the structure of the silica aerogel powder, dried using a general drying furnace, and (b) shows the structure of the silica aerogel powder, dried using a fluidized bed drying method. As shown in FIG. 3, it can be seen that the silica aerogel powder dried using a fluidized bed drying method has a uniform particle diameter distribution, compared to the silica aerogel powder dried using a general drying furnace. This phenomenon may be a peculiar characteristic of the fluidized bed drying method.

As described above, although the technical feature of the method of fabricating superhydrophobic silica-based powder of the present invention has been described with reference to the attached drawings, which is set forth to illustrate the preferred embodiment of the present invention, and is not to be construed as the limit of the present invention.

Further, those skilled in the art will appreciate that various modifications, additions and substitutions are possible, without departing from the scope and spirit of the invention as disclosed in the accompanying claims.

The superhydrophobic silica-based powder, fabricated using the method of the present invention, can be variously used in the fields of energy, environment, electricity/electronics, and the like. That is, it can be used as transparent/translucent insulation materials, polyurethane alternatives, and interior and exterior materials for building in the field of energy, can be applied to gas/liquid separation filters, catalyst systems for removing VOC/NOx in the environmental field, can be used as interlayer dielectric films for semiconductor and microwave circuit materials in the electric/electronic fields, and can be used as sound absorbing paints, sound absorbing panels and other sound absorbing materials, and raw materials for cold light in other fields.

1. A method of fabricating superhydrophobic silica-based powder, comprising:
a) forming a hydrogel by adding an organosilane compound having alkaline pH and an inorganic acid to a non-ion-exchanged water glass solution, which is a precursor, to form a mixed solution, and then surface-modifying and gelating the mixed solution;
b) dipping the hydrogel into a nonpolar solvent to solvent-exchange the hydrogel and remove sodium ions (Na⁺) therefrom; and
c) drying the solvent-exchanged hydrogel through a fluidized bed drying method under normal pressure or reduced pressure to fabricate aerogel powder.

2. The method of fabricating superhydrophobic silica-based powder according to claim 1, wherein the water glass solution is an inorganic precursor containing 29 wt % of silica, and is used in the range of 1 to 10 wt % by diluting the precursor with deionized water.

3. The method of fabricating superhydrophobic silica-based powder according to claim 1, wherein the organosilane compound is hexamethyldisilazane (HMDS).

4. The method of fabricating superhydrophobic silica-based powder according to claim 1, wherein the inorganic acid is acetic acid or hydrochloric acid.

5. The method of fabricating superhydrophobic silica-based powder according to claim 1, wherein the surface modifying the mixed solution, formed by adding the organosilane compound to the water glass solution, is conducted through a co-precursor method.

6. The method of fabricating superhydrophobic silica-based powder according to claim 5, wherein the hydrogel, obtained through the co-precursor method, is dipped into a nonpolar solvent to solvent-exchange the hydrogel and remove sodium ions (Na⁺) therefrom.

7. The method of fabricating superhydrophobic silica-based powder according to claim 1, wherein the solvent-exchanging the hydrogel and the removing sodium ions (Na+) from the hydrogel are conducted at a temperature ranging from room temperature to 60° C. within 10 hours.

8. The method of fabricating superhydrophobic silica-based powder according to claim 1, wherein the nonpolar solvent is hexane or heptane.

9. The method of fabricating superhydrophobic silica-based powder according to claim 1, wherein the drying of the solvent-exchanged hydrogel is conducted at a temperature ranging from 100° C. to 200° C.

10. The method of fabricating superhydrophobic silica-based powder according to claim 1, wherein the nonpolar solvent is recollected by the condensation of vapor in the drying of the solvent-exchanged hydrogel.

11. The method of fabricating superhydrophobic silica-based powder according to claim 1, further comprising, between step b) and step c): washing the hydrogel with water.

12. The method of fabricating superhydrophobic silica-based powder according to claim 1, further comprising, between step b) and step c): applying a vacuum or pressure to the hydrogel to remove moisture therefrom.

13. The method of fabricating superhydrophobic silica-based powder according to claim 1, further comprising, between step b) and step c): washing the hydrogel with water, and then applying a vacuum or pressure to the washed hydrogel to remove moisture therefrom.

14. The method of fabricating superhydrophobic silica-based powder according to claim 1, wherein, between step b) and step c): a vacuum or pressure is applied to the hydrogel to remove moisture therefrom, glass beads are put into the moisture-removed hydrogel, and then air having a temperature ranging from 100° C. to 200° C. is supplied thereto to easily discharge a solvent through fluidization and friction.

15. The method of fabricating superhydrophobic silica-based powder according to claim 14, wherein the aerogel powder dried through the fluidized bed drying method is separated and collected by density using the supplied air.

16. The method of fabricating superhydrophobic silica-based powder according to claim 14, wherein a superficial velocity of the air is 3˜15 times a minimum fluidization velocity of the glass beads in the fluidized bed.

17. The method of fabricating superhydrophobic silica-based powder according to claim 14, wherein a weight of the glass beads is 2˜6 times a weight of the hydrogel, from which moisture and some of hexane are removed.

18. The method of fabricating superhydrophobic silica-based powder according to claim 14, wherein the glass beads have a diameter of 1.0 mm or less.

19. The method of fabricating superhydrophobic silica-based powder according to claim 15, wherein a superficial velocity of the air is 3˜15 times a minimum fluidization velocity of the glass beads in the fluidized bed.

20. The method of fabricating superhydrophobic silica-based powder according to claim 15, wherein a weight of the glass beads is 2˜6 times a weight of the hydrogel, from which moisture and some of hexane are removed.

21. The method of fabricating superhydrophobic silica-based powder according to claim 15, wherein the glass beads have a diameter of 1.0 mm or less.
